(19) United States
(12) Patent Application Publication
(10) Pub. No.: US 2012/0023325 A1
(43) Pub. Date: Jan. 26, 2012

(54) VIRTUAL PRIVATE NETWORK SYSTEM AND NETWORK DEVICE THEREOF

(75) Inventor: Chung-Chiu Lai, Hsinchu County (TW)

(73) Assignee: GEMTEK TECHNOLOGY CO., LTD., Hsinchu (TW)

(21) Appl. No.: 12/868,709

(22) Filed: Aug. 25, 2010

(30) Foreign Application Priority Data
Jul. 20, 2010 (TW) 99123832

(51) Int. Cl. H04L 29/06

(52) U.S. Cl. 713/155

(57) ABSTRACT

A virtual private network (VPN) system and a network device thereof are provided. The VPN system includes a first network device, a second network device, and an authentication server. The first network device provides an encrypted connection setup request message containing an authentication information to the second network device. The second network device receives the encrypted connection setup request message and forwards the authentication information to the authentication server to perform a first authentication process, so as to determine whether the first network device is authorized. If the first network device is authorized, the first network device and the second network device directly exchange a set of VPN arguments and perform a second authentication process through the exchange of the VPN arguments, so as to establish an IPSec VPN connection between the first network device and the second network device.

### CROSS-REFERENCE TO RELATED APPLICATION

This application claims the priority benefit of Taiwan application serial no. 99123832, filed on Jul. 20, 2010. The entirety of the above-mentioned patent application is hereby incorporated by reference herein and made a part of this specification.

### BACKGROUND OF THE INVENTION

1. Field of the Invention

The present invention generally relates to a virtual private network (VPN) system, and more particularly, to a VPN system based on IPsec VPN connections and a network device thereof.

2. Description of Related Art

Virtual private network (VPN) technology is presently considered one of most effective techniques for accomplishing cloud computing. A client device (or an electronic device) has to establish a VPN connection with a VPN server through the Internet to use functionalities provided by other servers in the current domain of the VPN server.

There are three conventional techniques for establishing a VPN connection. According to the first technique, a user configures VPN arguments in a client device (for example, a computer) according to arguments provided by a network administrator. However, this technique requires the user to be familiar with related operations and settings and is usually very complicated so that errors may be produced during the argument configuration process. Therefore, this technique is very inconvenient to many users.

According to the second technique, the user installs a VPN client software in the client device, loads VPN server arguments provided by the network administrator, and inputs a preset username and a corresponding password to establish a connection. However, the authentication information (i.e., the username and the corresponding password) may be compromised, and the VPN server arguments have to be loaded again when the user operates another client device to connect to the VPN. Therefore, this technique is neither secure nor convenient to many users.

According to the third technique, the user inputs a preset username and a corresponding password into the client device and obtains a connection based on the secure socket layer (SSL) protocol. However, since the VPN connection is established based on the SSL protocol in this technique, it takes a longer time to establish the connection, and the username and the corresponding password may still be easily compromised. Therefore, this technique is still not secure or convenient, either.

### SUMMARY OF THE INVENTION

Accordingly, the invention is directed to a virtual private network (VPN) system based on IPsec VPN connections and a network device thereof. In the VPN system, a client device sends an encrypted authentication information to a VPN server through a connection setup request message. An authentication server performs a first authentication process and determines whether the client device is an authorized network device according to the encrypted authentication information. Besides, the client device and the VPN server directly exchange VPN arguments to perform a second authentication process, so as to establish an IPSec VPN connection. The IPSec VPN connection is quickly established and secure, and the VPN arguments thereof can be dynamically adjusted.

According to an exemplary embodiment of the invention, a VPN system is provided. The VPN system includes a first network device, a second network device, and an authentication server. The first network device provides a connection setup request message, wherein the connection setup request message contains an authentication information. The second network device connected to the first network device receives the connection setup request message and forwards the authentication information to the authentication server to perform a first authentication process and determine whether the first network device is authorized. If the first network device is authorized, the first network device and the second network device directly exchange a set of VPN arguments and perform a second authentication process through the exchange of the VPN arguments, so as to establish an IPSec VPN connection.

According to an exemplary embodiment of the invention, a network device adapted for establishing a VPN connection with another network device is provided. The network device includes a network interface, a memory module, and a processor module. The network interface is configured for connecting to the Internet. The memory module includes an argument generation module and a connection processing module. The connection processing module coupled to the network interface receives an encrypted connection setup request message from a client device and forwards the encrypted connection setup request message to an authentication server to perform a first authentication process and determine whether the client device is authorized, wherein the encrypted connection setup request message contains an authentication information. The argument generation module coupled to the connection processing module generates a set of VPN arguments, where the VPN arguments include a pre-shared key. The processor module is coupled to the network interface and the memory module, executes the argument generation module and the connection processing module and controls the network interface and the memory module. In addition, if the authentication server determines that the client device is authorized, the network device and the client device directly exchange a set of VPN arguments and perform a second authentication process through the exchange of the VPN arguments, so as to establish an IPsec VPN connection.

According to an exemplary embodiment of the invention, a network device adapted for establishing a VPN connection with another network device is provided. The network device includes a network interface, a memory module, and a processor module. The network interface is configured for connecting to the Internet. The memory module includes a user interface module and an encryption module. The user interface module coupled to the network interface receives an authentication information and a server address from a user and generates a connection setup request message and sends an encrypted connection setup request message to a server according to the server address. The server forwards the encrypted connection setup request message to an authentication server to perform a first authentication process and determine whether the network device is authorized, where the encrypted connection setup request message contains the authentication information. The encryption module coupled to the user interface module encrypts the connection setup request message into the encrypted connection setup request message. The processor module is coupled to the network interface and the memory module executes the user interface module and the encryption module, and controls the network interface and the memory module. Besides, if the network device is authorized, the server and the network device directly exchange a set of VPN arguments and perform a second authentication process through the exchange of the VPN arguments, so as to establish an IPsec VPN connection between the server and the network device.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a system block diagram of a virtual private network (VPN) system according to an exemplary embodiment of the invention.

FIG. 1B is a system block diagram of a VPN system according to another exemplary embodiment of the invention.

FIG. 2A is a functional block diagram illustrating a client device according to an exemplary embodiment of the invention.

FIG. 2B is a functional block diagram illustrating a VPN server according to an exemplary embodiment of the invention.

FIG. 3 is a flowchart of a VPN connection setup method according to an exemplary embodiment of the invention.

FIG. 4 is a flowchart of another VPN connection setup method according to another exemplary embodiment of the invention.

FIG. 5 is a flowchart of another VPN connection setup method according to another exemplary embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are configured in the drawings and the description to refer to the same or like parts.

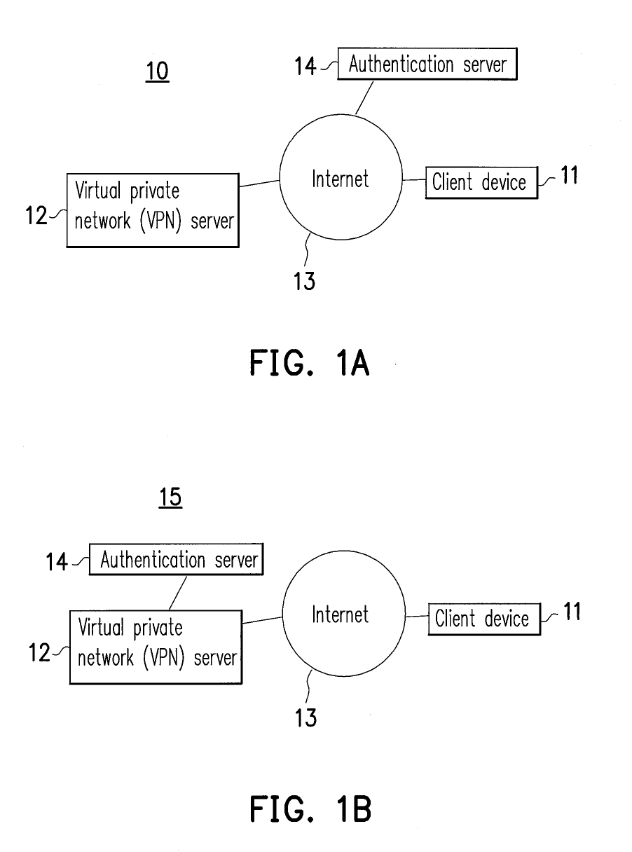

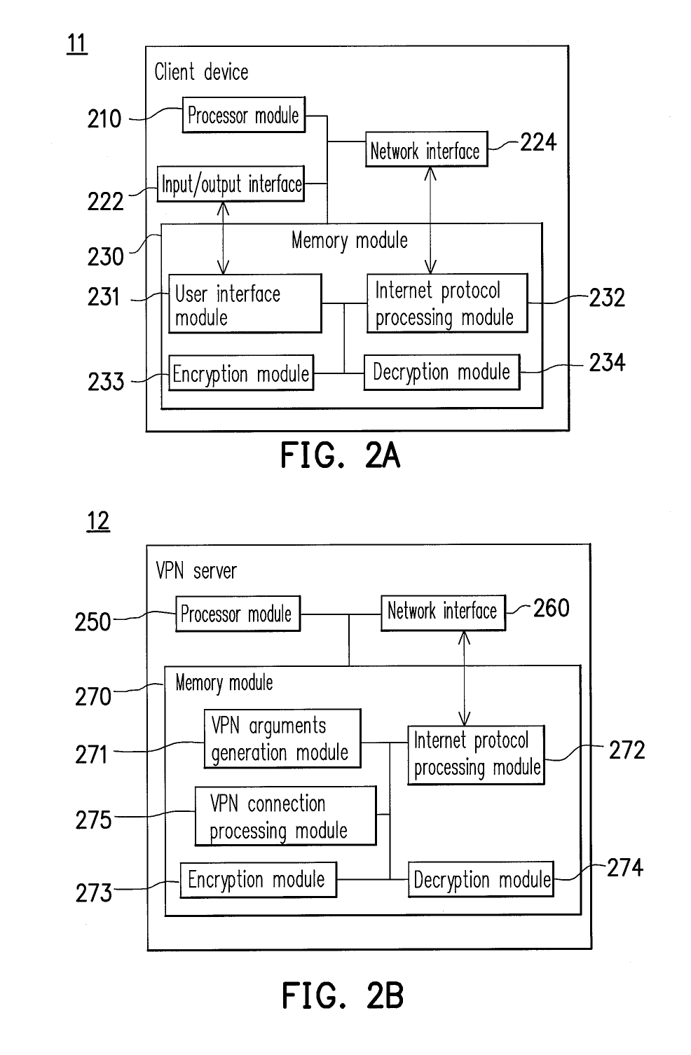

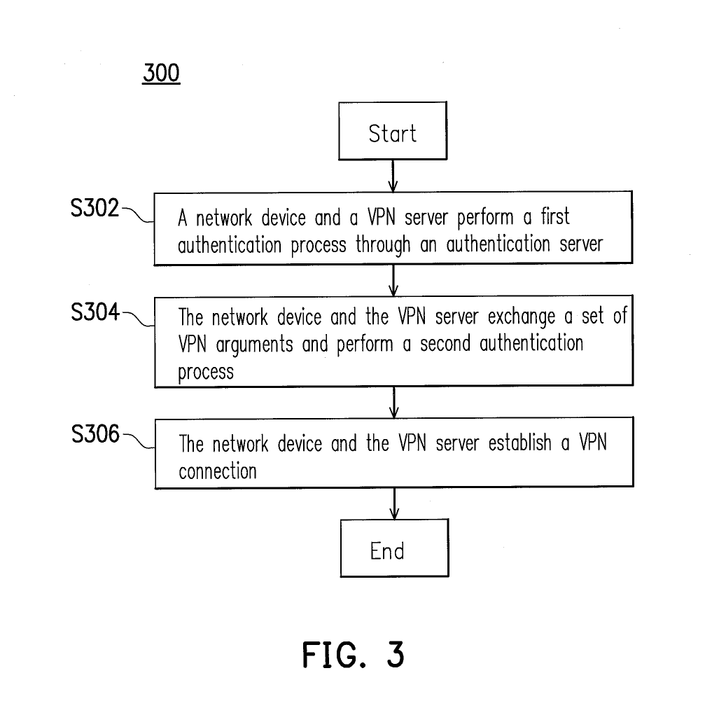

As described above, the invention provides a virtual private network (VPN) system based on IPSec VPN connections and a network device thereof. The structure of a VPN system will be described with reference to FIG below with reference to 1A and FIG. 1B, the functions of a client device and a VPN server in the VPN system will be described with reference to FIG. 2A and FIG. 2B, and the method of establishing a VPN connection will be described with reference to FIG. 3-FIG. 5.

FIG. 1A is a block diagram of a VPN system 10 according to an exemplary embodiment of the invention. Referring to FIG. 1A, the VPN system 10 includes at least one client device 11, a VPN server 12, an Internet 13, and an authentication server 14. The client device 11 is connected to the VPN server 12 through the Internet 13, and the VPN server 12 is connected to the authentication server 14 through the Internet 13.

In the present exemplary embodiment, the client device 11 provides an encrypted connection setup request message to the VPN server 12, where the encrypted connection setup request message contains at least an authentication information and a certificate. The VPN server 12 receives the encrypted connection setup request message and forwards the authentication information to the authentication server 14 to perform an authentication process, so as to determine whether the client device 11 is authorized. If the authentication server 14 determines that the client device 11 is authorized, the VPN server 12 and the client device 11 directly exchange a set of VPN arguments and perform another authentication process through the exchange of the VPN arguments. Accordingly, an IPsec argument exchange process is realized through the exchange of the VPN arguments, such that an IPSec VPN connection is established between the client device 11 and the VPN server 12. Herein the encrypted connection setup request message may be encrypted through a datagram transport layer security (DTLS) technique.

In the present exemplary embodiment, a user can directly operate the client device 11 to use services and functionalities provided by other servers (not shown) in the domain to which the VPN server 12 belongs, such as accessing a file server, accessing emails, using an internal instant message service, and accessing an internal database. The client device 11 is an electronic device, such as a desktop computer, a notebook computer, a smart phone, a personal digital assistant (PDA), a TV set, a multimedia player, or a mobile communication device. In addition, the user directly inputs a desired authentication information in the client device 11 to establish a VPN connection with the VPN server 12, where the authentication information may be a username and a password, a certificate that is obtained and loaded into the client device 11 in advance, a biological characteristic (for example, a fingerprint characteristic or a retinal characteristic), or a certificate on a smart card.

In the present exemplary embodiment, when the client device 11 and the VPN server 12 exchange the VPN arguments, the client device 11 sends a first IP address of a local area network (LAN) to which the client device 11 belongs to the VPN server 12, and the VPN server 12 sends a second IP address of another LAN to which the VPN server 12 belongs back to the client device 11. After exchanging the IP addresses of their own LANs, when the client device 11 and the VPN server 12 has exchanged the VPN arguments, the client device 11 further sends a third IP address of a wide area network (WAN) to which the client device 11 belongs to the VPN server 12, and the VPN server 12 sends a fourth IP address of another WAN to which the VPN server 12 belongs back to the client device 11. In addition, the VPN server 12 dynamically generates a pre-shared key and sends the pre-shared key to the client device 11 to complete the second authentication process and thus establish an IPSec VPN connection, where the second authentication process is a VPN authentication process.

In another exemplary embodiment, the VPN server 12 selectively sends a domain name system (DNS) information to the client device 11 such that the client device 11 is connected to a DNS server (not shown) in the domain of the VPN server 12. Accordingly, the client device 11 can be connected to one or more network servers (not shown) in the LAN to which the VPN server 12 belongs by using a domain name and use the services and functionalities provided by these network servers. If the VPN server 12 does not send the DNS information to the client device 11, the client device 11 cannot be directly connected to the network servers in the LAN to which the VPN server 12 belongs by using the domain name. Instead, the client device 11 has to be connected to these network servers (to use the services and functionalities provided by these network servers) by using IP addresses.

FIG. 1B is a block diagram of a VPN system 15 according to another exemplary embodiment of the invention. Referring to FIG. 1B, the VPN system 15 is similar to the VPN system 10 illustrated in FIG. 1A, and the difference between the VPN system 15 and the VPN system 10 is that, in the VPN system 15, the VPN server 12 is not connected to the authentication server 14 through the Internet 13 because the authentication server 14 and the VPN server 12 belong to the same LAN. However, this is not intended to limit the present invention. The VPN server 12 and the authentication server 14 may belong to the same domain or be integrated together.

FIG. 2A is a functional block diagram illustrating the client device 11 according to an exemplary embodiment of the invention. Referring to FIG. 2A, the client device 11 includes a processor module 210, an input/output interface 222, a network interface 224, and a memory module 230. The memory module 230 includes a user interface module 231, an Internet protocol processing module 232, an encryption module 233, and a decryption module 234.

Referring to FIG. 2A, the network interface 224 connects the client device 11 to the Internet through a wired communication technique or a wireless communication technique. The user interface module 231 of the client device 11 is connected to the Internet protocol processing module 232 and the input/output interface 222 and coupled to the network interface 224. The user interface module 231 receives an authentication information and a server address from a user and generates a connection setup request message and sends an encrypted connection setup request message to a VPN server (for example, the VPN server 12 in FIG. 1A) according to the server address. The VPN server 12 forwards the encrypted connection setup request message to the authentication server 14 to perform a first authentication process, so as to determine whether the client device 11 is authorized. The encrypted connection request message contains the authentication information, such as a username and a password, a certificate that is obtained and loaded into the client device 11 in advance, a biological characteristic (for example, a fingerprint characteristic or a retinal characteristic), or a certificate on a smart card.

Referring to FIG. 2A, the encryption module 233 is connected to the user interface module 231 and the Internet protocol processing module 232, and is configured to encrypt the connection setup request message into an encrypted connection setup request message, where the DTLS technique may be adopted by the encryption module 233 to accomplish the encryption process. The decryption module 234 is connected to the user interface module 231 and the Internet protocol processing module 232, and is configured to decrypt an encrypted data or an encrypted information sent to the user interface module 231 of the client device 11 by a VPN server. The Internet protocol processing module 232 may be a software module or a firmware module for processing information or network packets related to an Internet protocol stack.

Referring to FIG. 2A, the input/output interface 222 is connected to the network interface 224 and the processor module 210, and is configured for connecting to a biological characteristic sampler or a smart card reader. When the input/output interface 222 is connected to a biological characteristic sampler, the input/output interface 222 receives a biological characteristic (for example, a fingerprint characteristic or a retinal characteristic) from the user through the biological characteristic sampler and generates the authentication information according to the biological characteristic. When the input/output interface 222 is connected to a smart card reader, the input/output interface 222 receives a digital characteristic from a smart card and generates the authentication information according to the digital characteristic. In addition, the processor module 210 is coupled to the input/output interface 222, the network interface 224, and the memory module 230. The processor module 210 executes the user interface module 231, the Internet protocol processing module 232, the encryption module 233, and the decryption module 234. In addition, the processor module 210 controls and coordinates the input/output interface 222, the network interface 224, and the memory module 230.

However, the invention is not limited thereto, and in another embodiment, the Internet protocol processing module 232, the encryption module 233, and the decryption module 234 may be replaced by hardware units, and the processor module 210 controls and coordinates the Internet protocol processing unit (not shown), the encryption module unit (not shown), and the decryption module unit (not shown).

FIG. 2B is a functional block diagram illustrating the of the VPN server 12 according to an exemplary embodiment of the invention. Referring to FIG. 2B, the VPN server 12 includes a processor module 250, a network interface 260, and a memory module 270. The memory module 270 includes at least a VPN argument generation module 271, an Internet protocol processing module 272, an encryption module 273, a decryption module 274, and a VPN connection processing module 275.

Referring to FIG. 2B, the network interface 260 connects the VPN server 12 to the Internet through a wired communication technique or a wireless communication technique. The VPN argument generation module 271 is connected to the Internet protocol processing module 272 and coupled to the network interface 260. The VPN argument generation module 271 generates a set of VPN arguments, where the VPN arguments include a pre-shared key. The encryption module 273 and the decryption module 274 are connected to the VPN argument generation module 271, the Internet protocol processing module 272, and the VPN connection processing module 275. The encryption module 273 and the decryption module 274 are respectively similar to the encryption module 233 and the decryption module 234 of the client device 11 therefore the encryption module 273 and the decryption module 274 will not be described in details herein. The Internet protocol processing module 272 is connected to the network interface 260 and the VPN argument generation module 271. The Internet protocol processing module 272 is similar to the Internet protocol processing module 232 therefore the Internet protocol processing module 272 will not be described in details herein.

Referring to FIG. 2B, the VPN connection processing module 275 is connected to the VPN argument generation module 271, the Internet protocol processing module 272, the encryption module 273, and the decryption module 274. The VPN connection processing module 275 receives an encrypted connection setup request message from a client device (for example, the client device 11 in FIG. 1A) and forwards the encrypted connection setup request message to an authentication server (for example, the authentication server 14 in FIG. 1A) to perform a first authentication process and determine whether the client device 11 is authorized, where the encrypted connection setup request message contains the authentication information. The processor module 250 is coupled to the network interface 260 and the memory module 270, and is configured to execute the VPN argument generation module 271, the Internet protocol processing module 272, the encryption module 273, the decryption module 274, and the VPN connection processing module 275. In addition, the processor module 250 controls and coordinates the network interface 260 and the memory module 270.

However, the invention is not limited to foregoing descriptions, and in another embodiment, the VPN argument generation module 271, the Internet protocol processing module 272, the encryption module 273, and the decryption module 274 may also be replaced by hardware units, and the processor module 250 controls and coordinates the VPN argument generation unit (not shown), the Internet protocol processing unit (not shown), the encryption module unit (not shown), and the decryption module unit (not shown).

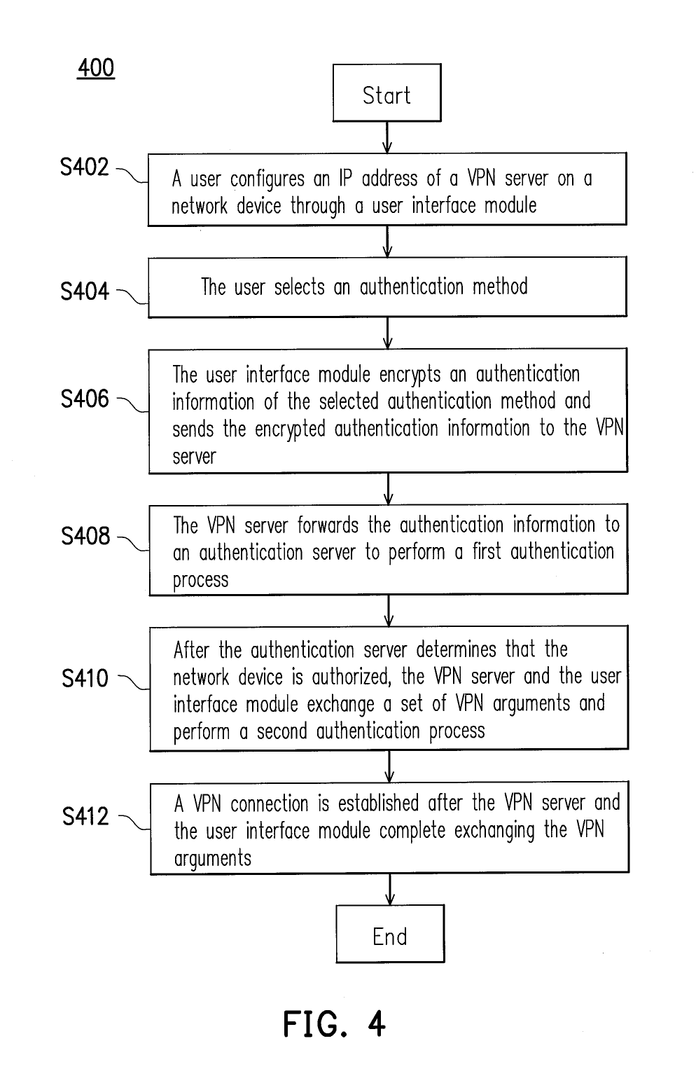

FIG. 3 is a flowchart of a VPN connection setup method 300 according to an exemplary embodiment of the invention. Referring to both FIG. 1A and FIG. 3, the VPN connection setup method 300 is started from step S302, where a network device (for example, the client device 11) and a VPN server (for example, the VPN server 12) perform a first authentication process through a authentication server (for example, the authentication server 12) (step S302). The network device and the VPN server exchange a set of VPN arguments and perform a second authentication process (step S304). The network device and the VPN server establish a VPN connection (step S306). The VPN connection setup method 300 is terminated here. The VPN connection setup method will be further described in detail below with reference to FIG. 4.

FIG. 4 is a flowchart of a VPN connection setup method 400 according to another exemplary embodiment of the invention. Referring to FIG. 1A, FIG. 2A, FIG. 2B, and FIG. 4, the VPN connection setup method 400 is startsed from step S402, where a user configures the Internet address of a VPN server (for example, the VPN server 12) on a network device (for example, the client device 11) through a user interface module (for example, the user interface module 231) (step S402).

In the present exemplary embodiment, the user also selects an authentication method and provides the corresponding authentication information (step S404). In the authentication method, a username and a password are input, a certificate is loaded into the network device, a biological characteristic (for example, a fingerprint characteristic or a retinal characteristic) is provided, or a certificate on a smart card is provided. The corresponding authentication information may be the username and password, the certificate loaded into the network device, the biological characteristic, or the certificate on the smart card. For example, when the user chooses to authenticate by using the biological characteristic, the user connects the input/output interface 222 of the client device 11 to a biological characteristic sampler to receive a biological characteristic (for example, a fingerprint characteristic or a retinal characteristic) from the user through the biological characteristic sampler and generate the authentication information according to the biological characteristic. Additionally, when the user chooses to authenticate by using the certificate on the smart card, the user connects the input/output interface 222 of the client device 11 to a smart card reader to receive a digital characteristic (or a certificate) from a smart card and generate the authentication information according to the digital characteristic (or the certificate).

In the present exemplary embodiment, the user interface module 231 performs a encryption process (for example, encrypting the authentication information into an encrypted authentication information by using the encryption module 233) on the authentication information generated based on the selected authentication method, inserts the encrypted authentication information into a connection setup request message, and sends the connection setup request message to the desired VPN server (step S406). In another embodiment, the user interface module 231 may also insert the authentication information into the connection setup request message first and then encrypt the connection setup request message into an encrypted connection setup request message by using the encryption module 233, and finally, send the encrypted connection setup request message to the VPN connection processing module 275 of the desired VPN server 12.

In the present exemplary embodiment, the VPN server sends the authentication information of the user to an authentication server to perform a first authentication process (step S408). To be more specific, the VPN connection processing module 275 of the VPN server 12 captures the encrypted authentication information from the connection setup request message and forwards the encrypted authentication information to the authentication server 14 to perform the first authentication process. Alternatively, in another embodiment, the VPN connection processing module 275 of the VPN server 12 captures the authentication information from the encrypted connection setup request message and forwards the authentication information to the authentication server 14 to perform the first authentication process.

In the present exemplary embodiment, after the authentication server 14 determines that the client device 11 is authorized (i.e., an authorized network device), the VPN server 12 and the user interface module 231 of the client device 11 exchange a set of VPN arguments and perform a second authentication process through the exchange of the VPN arguments (step S410). To be more specific, the user interface module 231 of the client device 11 sends a first Internet address of a LAN corresponding to the client device 11 to the connection processing module 275 of the VPN server 12, and the connection processing module 275 sends a second Internet address of a LAN to which the VPN server 12 belongs to the user interface module 231.

Similarly, the user interface module 231 of the client device 11 sends a third Internet address of a WAN to which the client device 11 belongs to the connection processing module 275 of the VPN server 12, and the connection processing module 275 sends a fourth Internet address of a WAN to which the VPN server 12 belongs to the user interface module 231. Besides, the VPN argument generation module 271 generates a pre-shared key and performs the second authentication process by sending the pre-shared key to the user interface module 231.

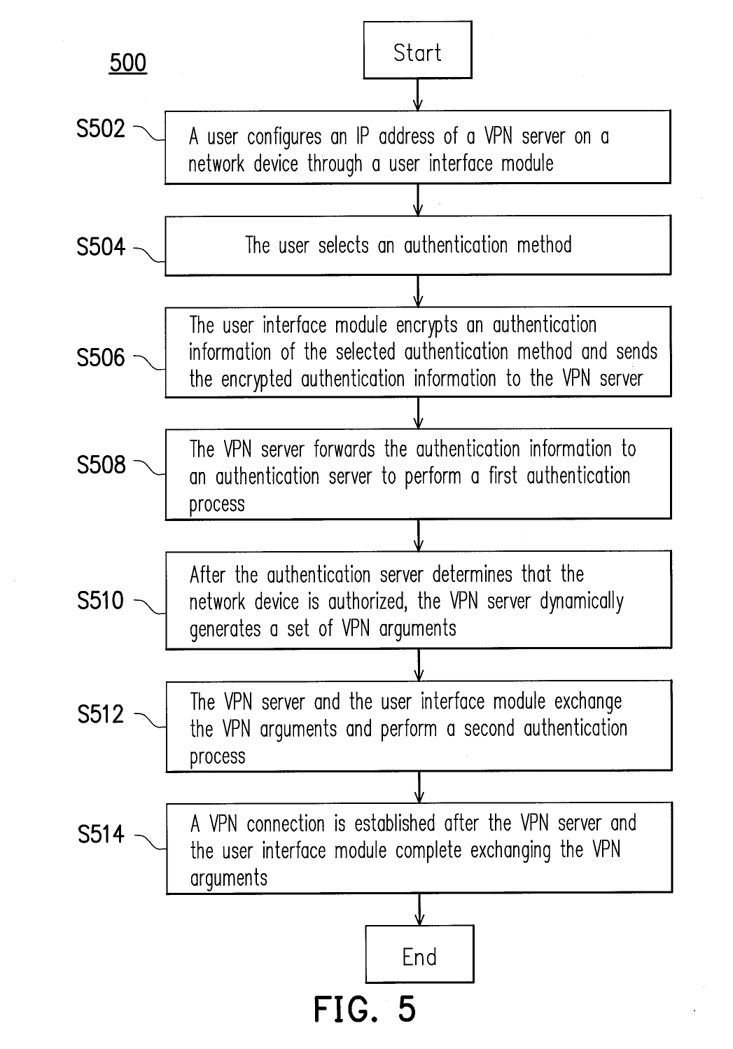

In the present exemplary embodiment, after the VPN server 12 and the user interface module 231 complete exchanging the VPN arguments and the subsequent second authentication process, a VPN connection is established (step S412), and the VPN connection setup method 400 is terminated here. The VPN connection is an IPSec VPN connection here. The user can connect to other network servers in the LAN or the domain to which the VPN server 12 belongs through this IPSec VPN connection by using the client device 11, so as to use the functionalities and services provided by these network servers. Another VPN connection setup method will be described below with reference to FIG. 5.

FIG. 5 is a flowchart of a VPN connection setup method 500 according to another exemplary embodiment of the invention. The steps S502-S508 in this VPN connection setup method 500 are similar to the steps S402-S408 in the VPN connection setup method 400 illustrated in FIG. 4 therefore the steps S502-S508 will not be described in details herein. Referring to FIG. 1A, FIG. 2A, FIG. 2B, FIG. 4, and FIG. 5, in step S510, after the authentication server 14 determines that the client device 11 is an authorized network device, the VPN server 12 dynamically generates a set of VPN arguments. To be more specific, the VPN argument generation module 271 of the VPN server 12 dynamically generates a pre-shared key and other related VPN arguments.

In step S512, the VPN server and the user interface module 231 exchange the VPN arguments and perform a second authentication process. To be more specific, the VPN connection processing module 275 sends the pre-shared key to the user interface module 231 of the client device 11 to complete the second authentication process, where the second authentication process is a VPN authentication process. Since the VPN arguments are dynamically generated, the user interface module 231 of the client device 11 are not required to store the VPN arguments permanently so that the security of the VPN connection can be effectively ensured when the user is about to establish another VPN connection by using another electronic device. The step S514 in the VPN connection setup method 500 is similar to the step S412 in the VPN connection setup method 400 therefore the step S514 will not be described in details herein. The VPN connection setup method 500 is terminated after step S514. In addition, the connection processing module 275 of the VPN server 12 selectively sends a DNS information to the user interface module 231 of the client device 11 such that the client device 11 is connected to one or more network servers in the LAN or the domain to which the VPN server 12 belongs by using a domain name.

In summary, the invention provides a VPN system and a network device thereof in exemplary embodiments described above. After a client device encrypts an authentication information, it inserts the encrypted authentication information into a connection setup request message and sends the connection setup request message to a VPN server. A first authentication process is performed, so as to determine whether the client device is an authorized network device, according to the encrypted authentication information through an authentication server. Besides, the client device and the VPN server directly exchange VPN arguments to perform a second authentication process, so as to establish an IPSec VPN connection. Thereby, the VPN system offers quick connection setup and secure connections and allows VPN arguments to be dynamically adjusted.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A virtual private network (VPN) system, comprising:
a first network device, configured for providing an encrypted connection setup request message, wherein the encrypted connection setup request message comprises an authentication information; and
a second network device, connected to the first network device through an Internet, configured for receiving the encrypted connection setup request message and forwarding the authentication information to an authentication server to perform a first authentication process and determines whether the first network device is authorized,
wherein if the first network device is authorized, the second network device and the first network device directly exchange a set of VPN arguments and perform a second authentication process by exchanging the VPN arguments, so as to establish an IPSec VPN connection between the first network device and the second network device.

2. The VPN system according to claim 1, wherein the first network device is a client device, and the second network device is a VPN server.

3. The VPN system according to claim 1, wherein when the second network device and the first network device exchange the VPN arguments, the first network device sends a first IP address of a local area network (LAN) to which the first network device belongs to the second network device, and the second network device sends a second IP address of a LAN to which the second network device belongs back to the first network device.

4. The VPN system according to claim 3, wherein when the second network device and the first network device exchange the VPN arguments, the first network device sends a third IP address of a wide area network (WAN) to which the first network device belongs to the second network device, and the second network device sends a fourth IP address of a WAN to which the second network device belongs back to the first network device.

5. The VPN system according to claim 3, wherein the second network device dynamically generates a pre-shared key and sends the pre-shared key to the first network device to complete the second authentication process, wherein the second authentication process is a VPN authentication process.

6. The VPN system according to claim 4, wherein the second network device selectively sends a domain name system (DNS) information to the first network device such that the first network device is connected to one or more network servers in the LAN corresponding to the second network device by using a domain name.

7. The VPN system according to claim 1, wherein the first network device is one of a computer, a smart phone, a personal digital assistant (PDA), a TV set, and a multimedia player.

8. A network device, for establishing a VPN connection with another network device, the network device comprising:
a network interface, configured for connecting to an Internet; and
a memory module, comprising:
a connection processing module, coupled to the network interface, configured for receiving an encrypted connection setup request message from a client device and forwarding the encrypted connection setup request message to an authentication server to perform a first authentication process and determine whether the client device is authorized, wherein the encrypted connection setup request message comprises an authentication information;
a argument generation module, coupled to the connection processing module, configured for generating a plurality of VPN arguments, wherein the VPN arguments comprise a pre-shared key; and
a processor module, coupled to the network interface and the memory module, configured for executing the argument generation module and the connection processing module and controlling the network interface and the memory module,
wherein if the client device is authorized, the network device and the client device directly exchange a plurality of VPN arguments and perform a second authentication process by exchanging the VPN arguments, so as to establish an IPSec VPN connection.

9. The network device according to claim 8, wherein the network device is a VPN server.

10. The network device according to claim 8, wherein when the network device and the client device exchange the VPN arguments, the connection processing module receives a first IP address of a LAN to which the client device belongs from the network device and sends a second IP address of a LAN to which the network device belongs to the client device.

11. The network device according to claim 10, wherein when the network device and the client device exchange the VPN arguments, the connection processing module receives a third IP address of a WAN to which the client device belongs from the network device and sends a fourth IP address of a WAN to which the network device belongs to the client device.

12. The network device according to claim 10, wherein the argument generation module dynamically generates the pre-shared key, and the connection processing module sends the pre-shared key to the client device to complete the second authentication process, wherein the second authentication process is a VPN authentication process.

13. The network device according to claim 12, wherein the connection processing module selectively sends a DNS information to the client device such that the client device is connected to one or more network servers in the LAN to which the network device belongs by using a domain name.

14. A network device, for establishing a VPN connection with another network device, the network device comprising:
a network interface, configured for connecting to an Internet; and
a memory module, comprising:
a user interface module, coupled to the network interface, configured for receiving an authentication information and a server address from a user, and generating a connection setup request message and sending an encrypted connection setup request message to a server according to the server address, wherein the server forwards the encrypted connection setup request message to an authentication server to perform a first authentication process and determine whether the network device is authorized, wherein the encrypted connection setup request message comprises the authentication information;
an encryption module, coupled to the user interface module, configured for encrypting the connection setup request message into the encrypted connection setup request message;
a processor module, coupled to the network interface and the memory module, configured for executing the user interface module and the encryption module and controlling the network interface and the memory module,
wherein if the network device is authorized, the another network device and the network device directly exchange a plurality of VPN arguments and perform a second authentication process by exchanging the VPN arguments, so as to establish an IPSec VPN connection between the another network device and the network device.

15. The network device according to claim 14, wherein the network device is a client device, and the another network device is a VPN server.

16. The network device according to claim 14, wherein when the network device and the another network device exchange the VPN arguments, the user interface module provides a first IP address of a LAN to which the network device belongs to the another network device and receives a second IP address of a LAN to which the another network device belongs.

17. The network device according to claim 16, wherein when the network device and the another network device exchange the VPN arguments, the user interface module provides a third IP address of a WAN to which the network device to the another network device belongs and receives a fourth IP address of a WAN to which the another network device belongs.

18. The network device according to claim 16, wherein the another network device dynamically generates a pre-shared key and sends the pre-shared key to the network device to complete the second authentication process, wherein the second authentication process is a VPN authentication process.

19. The network device according to claim 17, wherein the another network device selectively sends a DNS information to the network device such that the network device is connected to one or more network servers in the LAN corresponding to the another network device by using a domain name.

20. The network device according to claim 14 further comprising:
an input/output interface, configured for connecting to a biological characteristic sampler, receiving a biological characteristic provided by the user through the biological characteristic sampler, and generating the authentication information according to the biological characteristic.

21. The network device according to claim 14 further comprising:
an input/output interface, for connecting to a smart card reader, receiving a digital characteristic from a smart card, and generating the authentication information according to the digital characteristic.

22. The network device according to claim 14, wherein the authentication information comprises a username and a password.

23. The network device according to claim 14, wherein the network device is one of a computer, a smart phone, a PDA, a TV set, and a multimedia player.
